(19) United States
(12) Patent Application Publication
(10) Pub. No.: US 2022/0413843 A1
(43) Pub. Date: Dec. 29, 2022

(54) COMBINING MODEL-DRIVEN APPLICATIONS AND CANVAS-TYPE APPLICATIONS WITH APPLICATION LIFECYCLE MANAGEMENT

(71) Applicant: Microsoft Technology Licensing, LLC, Redmond, WA (US)

(72) Inventors: Bhavin Ashokkumar AGARWAL, Bellevue, WA (US); Gabriel Lionel Paul BOYER, Sammamish, WA (US); Sushil KUMAR, Lynnwood, WA (US); Dipanjan GHOSH, Redmond, WA (US); Yasser Elsayed Mohamed SHAABAN, Henderson, NV (US); Prabhat Kumar PANDEY, Redmond, WA (US); Syed Adnan AHMED, Sammamish, WA (US)

(21) Appl. No.: 17/361,275

(22) Filed: Jun. 28, 2021

(51) Int. Cl. G06F 8/71; G06F 8/36; G06F 8/41; G06F 8/34

(52) U.S. Cl. CPC G06F 8/71; G06F 8/36; G06F 8/44; G06F 8/34

(57) ABSTRACT

Systems and methods for generating an application store metadata corresponding to a plurality of sub-applications, combining model-driven application and canvas-type applications. Lifecycle components of the plurality of sub-applications are coupled to each other using one or more data relationships defined by an embedding model and the stored metadata. The metadata points to a library associated with the plurality of sub-applications, and wherein the library comprises a newest version of one or more of the lifecycle components. The compiled plurality of sub-applications can then be run.

### BACKGROUND

Generating an application using code generally requires knowledge of programming, data capabilities and compatibilities, and so forth. For example, creating an executable computer program generally involves generating algorithms, verifying the correctness of the algorithms, and implementing the algorithms into a programming language. This process often requires expertise in many areas, including coding in the target programming language.

Model-driven application design provides a component-focused approach to application development that simplifies creating an executable computer program. In many cases, model-driven application design does not require code from the user, and allows for designing or developing simple or complex applications. Unlike a canvas-type application development approach where the designer has complete control over the application layout, with the model-driven application approach, much of the layout is pre-determined and largely designated by the components added to the application during the design or development. However, in traditional systems, the component-focused approach and the canvas-type application development approach are not easily usable together during application development, which limits this hybrid-type approach from being used.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more examples, a computerized method for generating an application stores metadata corresponding to a plurality of sub-applications. The plurality of sub-applications comprise different types of applications. The method couples lifecycle components of the plurality of sub-applications using one or more data relationships defined by an embedding model and the stored metadata. The method further compiles the plurality of sub-applications into code. The stored metadata points to a library associated with the plurality of sub-applications, and wherein the library comprises a newest version of one or more of the lifecycle components.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is a block diagram of an example computing device for generating an application;

FIG. 2 is a block diagram of an example developer environment for generating an application;

FIG. 3 is another diagram illustrating an example developer environment for generating an application;

FIG. 4 illustrates an example model;

FIG. 5 illustrates an example workflow for designing a custom page;

FIG. 6 is a flowchart of an example process for creating an application; and

FIG. 7 illustrates an example computing apparatus as a functional block diagram.

Corresponding reference characters indicate corresponding parts throughout the drawings. In the figures, the systems are illustrated as schematic drawings. The drawings may not be to scale.

### DETAILED DESCRIPTION

Referring to the figures, computing devices and methods described herein are configured to combine the creation of logically organized applications (such as model-driven applications having a declarative layout based on a data model) and canvas-type applications (allowing free form design, such as control over the physical layout) into a single application with application lifecycle management (ALM) functionality. For example, canvas-type pages or portions are embedded within a logical application (such as a model-driven application) in a hybrid-type approach. As a result, applications are created that combine the advantages of model-driven and canvas-type applications using custom page technology. In various examples, a new intersect entity is provided that has the canvas-type application metadata information, and the model-driven application is linked to a root canvas-type application. This allows for management of the application lifecycle as described in more detail herein. The root canvas-type application acts as a container to all the custom pages associated with the model-driven application in various examples. As such, the canvas-type applications, also referred to as custom pages, are supported as part of the application module.

In one example, an application module entity in a database (e.g., a common data service) is used to build model-driven applications using existing components (e.g., canvas-type applications) that are native to the database, wherein the canvas-type applications are natively supported as a component of the application module. Various examples allow for designing and building applications (e.g., business applications) from a canvas. In one example, data is integrated from multiple sources into a single store, which can then be used together (e.g., canvas-type and model-driven components can be authored and published in the same lifecycle). It should be appreciated that various types of common data services can be used in some examples as a cloud-based storage to store data (e.g., business data) and the present disclosure is not limited to a particular operating environment. For example, different applications, services, connectors, and data platforms, such as in different suites can be used with the herein described examples to build applications (e.g., custom business applications). In some examples, applications are built that connect data that is stored in an underlying data platform or in online and on-premises data sources. As such, the present disclosure allow for deployment of an application to different environments that can include custom interfaces, tables, choices, and other components.

As a result of providing the above-described functionality and performing the operations described herein, the usage of processing time and processing resources by the underlying computer device is reduced. When a processor is programmed to perform the operations described herein, the processor is used in an unconventional way, and allows, for example, for more technically efficient creation of applications.

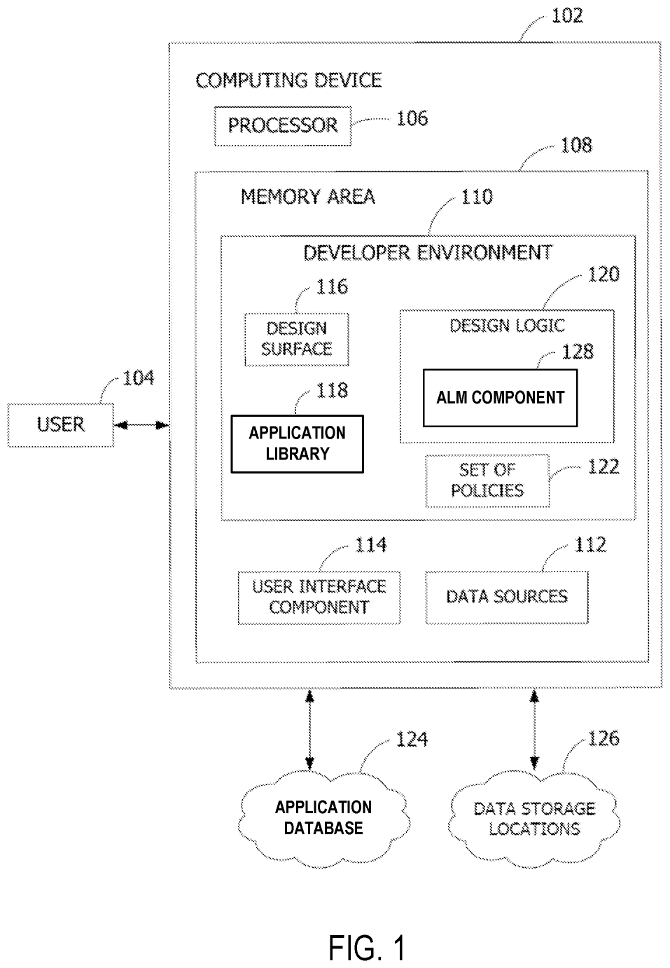

Referring to FIG. 1, a computing device 102 for generating an application is shown. The computing device 102 is associated with a user 104 and represents a system for application design in the illustrated example. The computing device 102 represents any device executing instructions (e.g., as application programs, operating system functionality, or both) to implement the operations and functionality as described herein. The computing device 102 may include a mobile computing device or any other portable device. In some examples, the mobile computing device includes a mobile telephone, laptop, tablet, computing pad, netbook, gaming device, and/or portable media player. The computing device 102 may also include less portable devices such as desktop personal computers, kiosks, tabletop devices, industrial control devices, wireless charging stations, and electric automobile charging stations. Additionally, the computing device 102 may represent a group of processing units or other computing devices.

In one example, as described in more detail herein, the computing device 102 is configured to:

1. Add native support for custom pages in a datastore as part of an application module, wherein metadata serves both application designer aspects of the feature and runtime aspects (e.g., a Generate Client Metadata (GCM));

2. Provide application module and custom page metadata to a resource provider (RP) system (e.g., a canvas-type RP system) as a unified application catalog and application packaging and launch orchestrator; and

3. Include a generic entity schema that can be used to add other components, such as other design components (e.g., data component, visualization component, etc.).

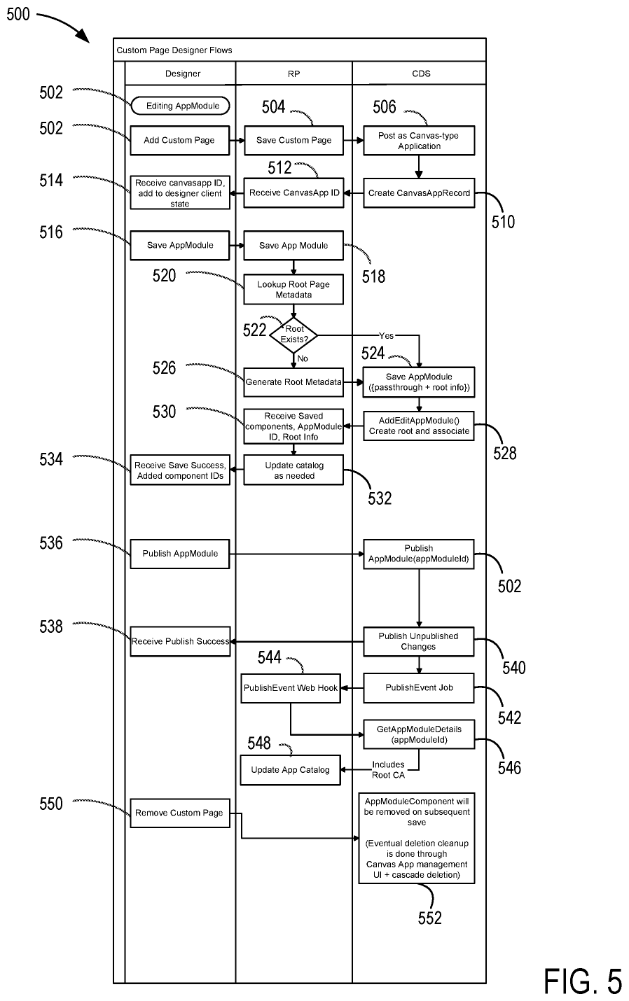

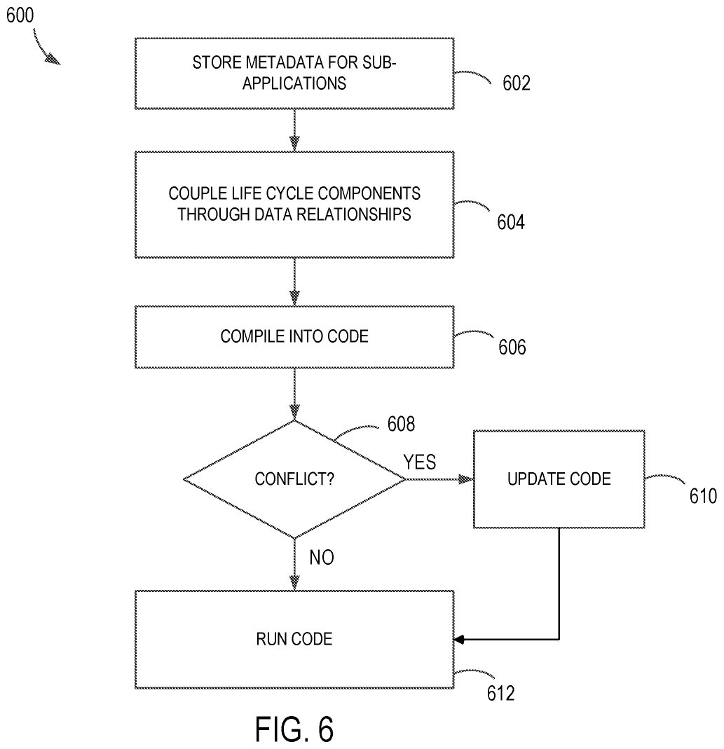

In some examples, the computing device has at least one processor 106, a memory area 108, and at least one user interface component 114. The processor 106 includes any quantity of processing units, and is programmed to execute computer-executable instructions for implementing aspects disclosed herein. The instructions may be performed by the processor 106 or by multiple processors 106 within the computing device 102, or performed by a processor external to the computing device 102. In some examples, the processor 106 is programmed to execute instructions such as those illustrated in the figures (e.g., FIG. 5 and FIG. 6).

In some examples, the processor 106 represents an implementation of analog techniques to perform the operations described herein. For example, the operations may be performed by an analog computing device and/or a digital computing device.

The computing device 102 further has one or more computer readable media such as the memory area 108. The memory area 108 includes any quantity of media associated with or accessible by the computing device. The memory area 108 may be internal to the computing device 102 (as shown in FIG. 1), external to the computing device 102 (not shown), or both (not shown). In some examples, the memory area 108 includes read-only memory and/or memory wired into an analog computing device.

The memory area 108 stores, among other data, one or more applications. The applications, when executed by the processor 106, operate to perform functionality on the computing device 102. Exemplary applications include a developer environment 110, which represents an application for designing other executable applications in some examples. The applications communicate with counterpart applications or services such as web services accessible via a network (not shown) in various examples. For example, the applications represent downloaded client-side applications that correspond to server-side services executing in a cloud. In some examples, the applications that are generated are configured to communicate with data sources and other computing resources in a cloud during runtime, or share and/or aggregate data between client-side services and cloud services. The memory area 108 stores data sources 112, which represent data stored locally at the memory area 108, data access points stored locally at the memory area 108 and associated with data stored remote from the computing device 102, or any combination of local and remote data.

The memory area 108 further stores one or more computer-executable components. Examples of components include the user interface component 114. The user interface component 114, when executed by the processor 106 of the computing device 102, causes the processor 106 to perform operations, including to receive user selections during user interaction with the developer environment 110, for example.

In some examples, the user interface component 114 operates with a graphics card for displaying data to the user and receiving data from the user. The user interface component 114 may include computer-executable instructions (e.g., a driver) for operating the graphics card. Further, the user interface component 114 may operate with a display (e.g., a touch screen display or natural user interface) and/or computer-executable instructions (e.g., a driver) for operating the display. The user interface component 114 may operate with one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user can input commands or manipulate data by moving the computing device 102 in a particular way. In another example, the user can input commands or manipulate data by providing a gesture detectable by the user interface component 114, such as a touch or tap of a touch screen display or natural user interface.

In one example, the developer environment 110 provides design tools and a design environment for application design and generation. In some examples, the developer environment 110 includes a design surface 116, an application library 118, design logic 120, and a set of policies 122. The design surface 116 includes an interactive canvas or interactive design surface of the developer environment 110. As used herein, in various examples, “canvas” and “canvas-type” refer to an arrangement that allows for a custom layout that includes at least control over the physical layout plus composition and low code expressions.

In some examples, the design surface 116 is part of an interactive graphical user interface displayed on an interactive computing device. For example, the design surface 116 is an interactive surface communicatively coupled to a gesture detection mechanism, such as a gesture detection component of a touchscreen, such that gestures detected are used to communicate interaction with the developer environment, or elements of the developer environment.

The application library 118 includes one or more applications (e.g., sub-applications, applets or pages) in some examples, which can be selected or used in application design. The application library 118 may include representations of application templates that are selectable from an application database 124 and customized via user interaction with the design surface 116. In this example, the application database 124 is located remote from the computing device 102 and accessible by the developer environment 110, such as in a cloud storage location. In other examples, the application database 124 is located at the memory area 108. The application library 118 periodically synchronizes with the application database 124 in some examples to receive updated metadata associated with templates corresponding to the applications from the application database 124 (e.g., updates relating to application module elements). In various examples, the one or more application templates correspond to sub-applications that are arranged together in the application library 118, illustrated as a single library. In some examples, the sub-applications are together arranged within different application libraries 118.

Example templates include application templates for, without limitation, asset management applications, catalog applications, contract applications, customer relationship management (CRM) applications, dashboard and report applications, events and calendars applications, timesheet applications, expense tracking and/or reporting applications, media applications, multi-media applications, personal management applications, travel applications, project management applications, and so on. In general, the example templates may be in template categories, with a number of application templates for each category. In some examples, each category has multiple layers of sub-categories. As one example, the application library 118 includes application templates for an asset management application template category, with application templates for site inspector applications, image-tagging applications, and other applications pertaining to asset management. The application library 118 in some examples provides another layer of templates under site inspector applications, providing various different site inspector application templates as well. In some examples, the different application templates provide different visual layout options or different data exposure components. In various examples, a template includes a document and a schema, the document providing the visual layout and components along with sample data populated according to the schema, as described in more detail herein. When a template is selected, and source data is received, the source data is wired to the visual layout and components of the template according to the template schema.

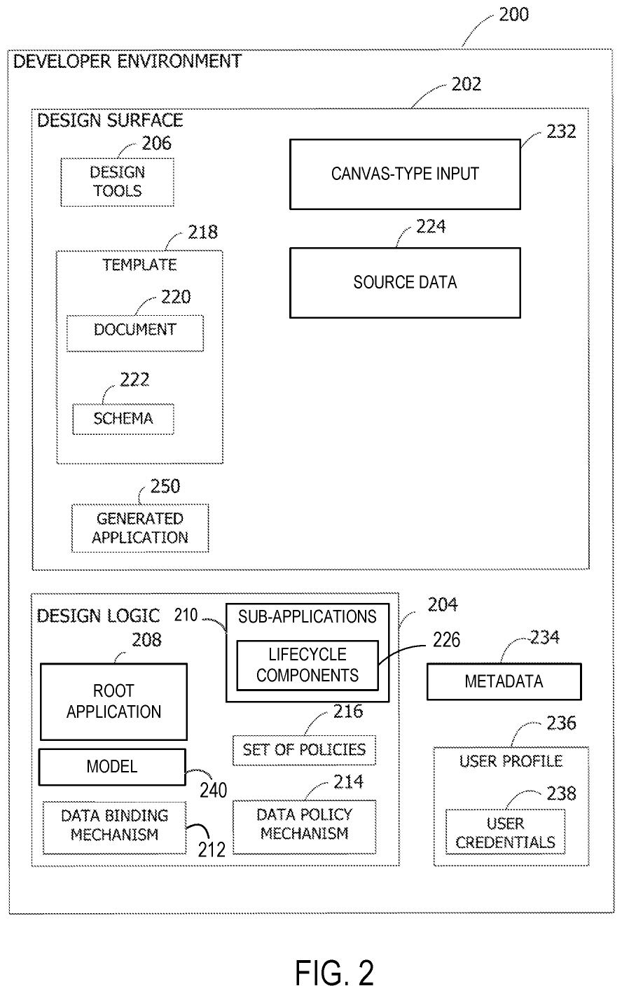

The design logic 120 is a component of the developer environment 110 that binds source data to a selected application template, identifies application data, extracts and stores application data based on user selections and/or a set of policies 122, and rewires, or re-binds, extracted data to the application generated using the template or canvas-type inputs. The design logic 120 in one example identifies data storage locations 126, which can include different versions of data (e.g., different versions of application or templates) that are managed in various examples. For example, the set of policies 122 in combination with an ALM component 128 couples one or more lifecycle components of the data stored in the data storage locations 126 through enforced data relationships as described in more detail herein. In one example, the ALM component 128 is configured to couple lifecycle components 226 (in FIG. 2) of a plurality of sub-applications 210 (in FIG. 2) in the application library 118 using one or more data relationships defined by an embedding model 240 (in FIG. 2) and using stored metadata 234 (in FIG. 2).

In one example, the data storage locations 126 are discovered by the developer environment 110 based on user credentials associated with the user 104. For example, the user 104 can log-in to the developer environment 110 with user credentials associated with a user profile accessible by the developer environment 110. In this example, the user profile stores data storage locations and associated credentials that the user 104 has previously used in interacting with the developer environment 110. In other examples, the developer environment 110 detects a data storage location associated with the user 104 based on user credentials, and prompts the user 104 to provide access to the detected data storage location via the design surface 116 (e.g., a canvas-type surface). In still other examples, the developer environment 110 is associated with an enterprise network, and one or more data storage locations corresponding to the enterprise network are provided as some of the data storage locations available for selection. In another example, the data storage locations 126 are provided to the developer environment 110 by a discovery service. In yet another example, the data storage locations 126 are provided to the developer environment 110 by the user 104.

Thus, the design logic 120 in some examples identifies application data for extraction based in part on the set of policies 122. The set of policies 122 can include, without limitation, rules and parameters associated data relationships, rules and parameters associated with a file size, a distribution list, historical data storage locations associated with a user, historical data storage locations associated with a type of data, historical data storage locations associated with a data policy, capacity of a data storage location, a type of data, permissions, data sensitivity, data restrictions, target storage access restrictions, how the application is using the data, a type of data being captured by the application, or any other suitable parameter. In addition to the set of policies 122, the design logic 120 in various examples identifies data for extraction and storage based on policies attached to the data, such as enterprise data.

FIG. 2 is a block diagram illustrating a developer environment for generating an application. The developer environment 200 is an illustrative example of one implementation of the developer environment 110 in FIG. 1. The developer environment 200 generally includes a design surface 202 and design logic 204 as described in more detail below.

The design surface 202 can be an interactive canvas for receiving templates, source data, and interactions with the templates and source data, which are used by the design logic 204 to automatically generate an application. For example, the design surface 202 is a portion of the developer environment 200 that is displayed via a user interface and is configured to receive user interaction. The design surface 202 can include design tools 206, which can be application resources of the developer environment 200. For example, the design tools 206 include the application library 118 of FIG. 1.

The design logic 204 in various examples includes a number of algorithms, rules, and parameters for automatically generating an application using a template and source data. As described in more detail herein, the design logic uses a root application 208 that allows for combining the creation of logically organized applications (such as model-driven applications) and canvas-type applications into a single application. In one example, the root application 208 is a container that is configured to embed canvas-type pages (e.g., custom pages) or portions within a logical application (such as a model-driven application). As used herein, in various examples, “model driven” refers to an arrangement that uses a declarative layout based on a data model (e.g., a form entry page).

In some examples, the root application 208 is a file or a representation of a data format that allows for embedding canvas-type pages, or portions thereof, within the logical application. In various examples, a set of policies 216 enforces ALM across a plurality of sub-applications 210 (e.g., the ALM component 128 (in FIG. 1) is configured to couple the lifecycle components 226 of the plurality of sub-applications 210 in the application library 118 (in FIG. 1) using one or more data relationships defined by the embedding model 240 and using stored metadata 234) linked by the root application 208, which includes updating a version of one or more of the sub-applications in the event of a conflict. For example, if there is a conflict between one or more of the sub-applications 210 (and/or one or more libraries used by the sub-applications 210), a most recent version of the one or more of the sub-applications 210 (and/or libraries) is used (e.g., pointed to) in order to resolve a conflict with new versions of other sub-applications 210 (and/or new versions of the libraries).

In various examples, ALM comprise the lifecycle management of the sub-applications 210, which includes governance, development, and maintenance. In some examples, ALM includes the following: requirements management, software architecture, development, testing, maintenance, change management, continuous integration, project management, deployment, and release management. In one or more examples, the ALM component 128 is configured as a tool that provide a standardized system for communication and collaboration between software development teams and related departments, such as test and operations. The tools can also automate the process of software development and delivery. To that end, in some examples, ALM combines the disciplines concerned with all aspects of the process to achieve the goal of driving efficiency through predictable and repeatable software delivery.

As discussed herein, the ALM component 128 is configured to couple the lifecycle components 226 of the plurality of sub-applications 210, which in one example includes an application lifecycle that is a cyclical software development process that involves at least the following: plan and track, develop, build and test, deploy, operate, monitor, and learn from discovery. The ALM component 128 is configured to perform ALM functions using one or more different platforms. In one example, ALM includes solutions that are the mechanism for implementing ALM, wherein the solutions are used to distribute the lifecycle components 226 across environments through export and import. In various examples, the lifecycle component 226 represents an element (e.g., entity) that can be customized. In some examples, anything that can be included in a solution is a lifecycle component 226, such as site maps, applications, entities, fields, charts, or plug-ins, among others.

As an example of the operation, the design surface 202 receives a template selection, illustrated by a template 218. The template 218 is an application template having a document 220 and a schema 222. The document 220 includes visual components and a visual layout for the application generated using the template 218, as well as sample data applied to the template using the schema 222. The sample data mapped based on the schema 222 provides a visual representation of how source data may be applied to the visual layout and visual components of the template 218, for application design. As one illustrative example, the document 220 provides a table and the sample data is mapped to the table based on the schema 222. In this example, the sample data is formatted as spreadsheet data, with the spreadsheet data mapped to the table in the template based on the schema 222. As another example, the document 220 provides a set of pages or set of screens of an application, and the schema 222 maps sample data of images, with an individual sample image for an individual screen.

The design surface 202 also receives source data 224 and a canvas-type input 232 (e.g., inputs from canvas-type applications, such as inputs for custom pages) provided by the user. In some examples, the user input includes opening a file or dragging a file onto the design surface 202 or interacting with the design surface 202 in a free form design way (e.g., designing an application by dragging and dropping elements onto a canvas). The source data 224 in some examples includes one or more different source files. For example, the source data 224 includes one or more of user data, remote data, shared data, enterprise data, public data, dynamic data, local data, or any other accessible data; and the canvas-type input 232 includes one or more of canvas-type data inputs, modifications, etc. In one example, canvas-type and model-driven pages are combined into a single, cohesive application tailored to the needs of the end user using the root application 208 having ALM enforced using the metadata 234 as described in more detail herein. Aspects of the disclosure can be used to craft a pixel-perfect user experience (UX), connect to hundreds of data sources, and leverage functionality for low-code logic that enables seamless embedding within model-driven applications.

As such, different applications can be combined with completely tailored custom screens (e.g., drop in robust, declaratively-generated grids and forms by selecting a table and preview the running application live in the developer environment 200, and craft custom pages, such as canvas-type pages, inline). That is, a canvas-type application is embedded on a model-driven form using custom page technology, wherein an intersect entity (illustrated as the root application 208) has access to the metadata 234 (e.g., the required canvas-type application metadata information) and the model-driven application (such as defined by one or more templates 218) is linked to the root application 208 (e.g., a root canvas-type application). In various examples, as described herein, the root application 208 acts as a container to all the custom pages associated to the model-driven application.

In some examples, a data policy mechanism 214 enforces policies, such as attached to or associated with the source data 224, as well as the set of policies 216 as described herein. In some examples, a data binding mechanism 212 rewires, or re-binds data, such as to update versions of one or more of the associated sub-applications 210. Application generation transforms the document 220 into a published application and binds the source data 224 and canvas-type input 232 to the application to form a generated application 250 (e.g., compile into code that can be executed).

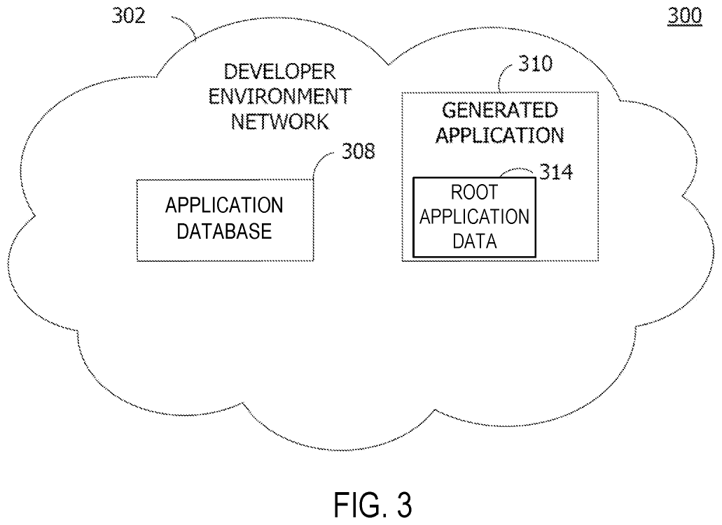

FIG. 3 is a diagram illustrating a developer environment 300 that can be an illustrative example of one implementation of the developer environment 110 in FIG. 1 and/or the developer environment 200 in FIG. 2.

The developer environment 300 includes a developer environment network 302 having cloud storage and one or more network devices for implementing components of the developer environment in various examples. In this example, an application database 308 is maintained at the developer environment network 302, and is accessible to instances of the developer environment. For example, the application library 118 in FIG. 1 is populated from the application database 308 to include a plurality of application templates corresponding to a plurality of model-driven applications. Upon publication via user selection to create an application from sub-applications corresponding to one or more model-based applications (selected from one or more templates) and one or more canvas-type applications (designed in a canvas-type application format), an application is automatically generated and stored in the developer environment network 302, represented by the generated application 310. Root application data 314 (corresponding to the root application 208 in FIG. 2) is configured as a container that combines the sub-applications for a hybrid design as described in more detail herein. The generated application 310 is then accessible to any user with which the application is shared or can be published for public access in some examples.

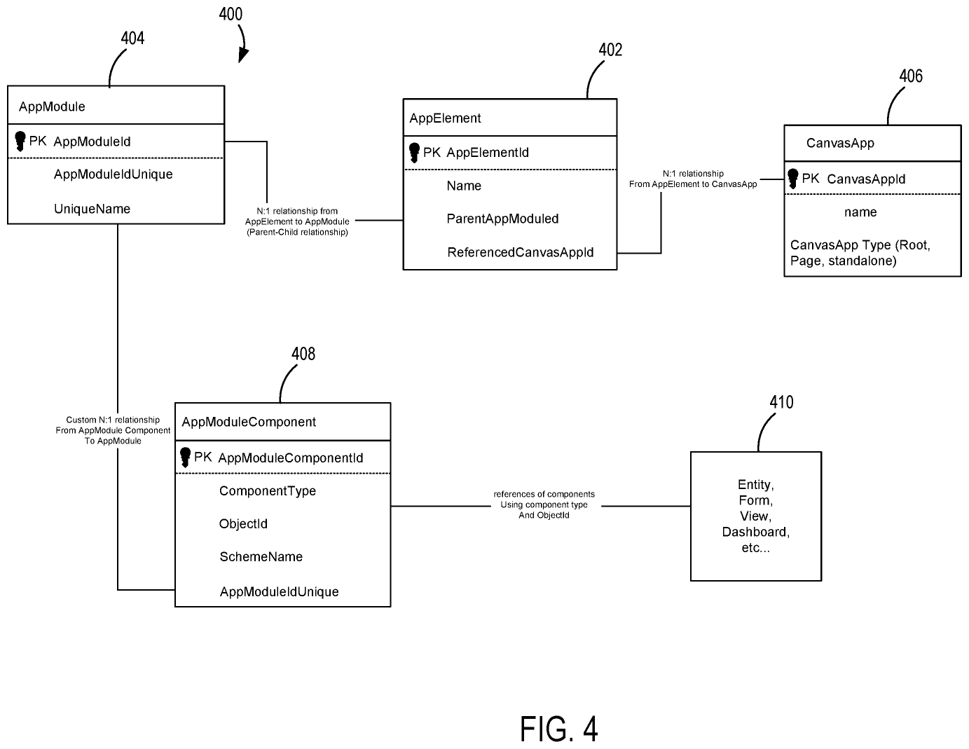

FIG. 4 illustrates a model 400 (e.g., an embedding model) including an application element (e.g., AppElement) 402 according to various examples, and which can be embodied as the model 240 (in FIG. 2). The model 400 is configured as a relationship driven model that links an application module (e.g., AppModule) entity 404 corresponding to one or more model-based applications and a canvas-type application entity 406 corresponding to one or more canvas-type applications. That is, using the root application (RootApp) 208 (in FIG. 2), the lifecycle of the various components of sub-applications defined by the one or more model-based applications and the one or more canvas-type applications are coupled together through enforced data relationships as illustrated by the model 400. That is, an N:1 relationship is defined from the application element entity 402 to the canvas-type application entity 406, and an N:1 relationship is defined from the application element entity 402 to the application module entity 404 (which in the illustrated example is a parent-child relationship). As can be seen, with the model 400, a custom N:1 relationship is thereby defined from one or more application module components (e.g., AppModuleComponent) entity 408 to the application module entity 404. In this example, the application module component entity 408 is linked to (references) components 410 using a component type and object identification (e.g., Objectid). For example, the application module component entity 408 is linked to an entity, form, view, dashboard, etc. In some examples, each of the entities has a unique key identification (e.g., a private key (PK) identification (ID)).

In one example, with the model 400, the application element entity 402 in a datastore is used to build model driven applications using existing components that are native to the datastore in which canvas-type applications are natively supported as a component of the application element entity 402. That is, the model 400 supports the canvas-type applications (canvas-type application entity 406), also referred to as custom pages, as part of the application module entity 404 using the defined relationships. For example, native support is provided for custom pages in the datastore as part of the application element entity 402, which includes metadata used in both application designer aspects of the feature and runtime aspects (e.g., a GCM). In one example, metadata for the application element entity 402 and canvas-type application 406 (e.g., custom page app module plus custom page metadata to canvas-type RP) are provided to allow for a unified application catalog and application packaging and launch orchestrator. As should be appreciated, with the herein described generic entity schema, other components can be added (e.g., data component, data visualization, etc.).

In various examples, the application element entity 402 stores all the metadata information for any of the components that need to be added to an application module (e.g., support canvas-type applications (e.g., custom pages) natively in the datastore as part of the application module). The application element entity 402 is configured as an intersect entity between the application module entity 404 and the canvas-type application entity 406 (and can be extended to refer to other external components or replace the application module component entity 408). To implement the custom pages feature, the application element entity 402 stores only a relationship to an underlying canvas-type record (e.g., the canvas-type application entity 406). However, in some examples, this is extended with configuration properties that configure how a component behaves within the context of a given application module component entity 408, such as lifecycle events, parameters, etc. For example, the one or more data component features use this schema. It should be noted that in various examples, the application element entity 402 is created within an existing data structure (e.g., using an infrastructure available for creating solution aware components) such that a custom handler is not needed. It should also be noted that the one or more entities can be differently defined or configured, such as based on the operating environment or platform, design program, type of datastore, etc.

Thus, since the application element entity 402 is modelled as an intersect entity, the application element entity 402 has the N:1 relationships with the application module entity 404, as well as the canvas-type application entity 406. In one example, the N:1 relationship with application module entity 404 is modelled as a parent-child relationship as described herein, such that no AppElements exist if the parent application module is deleted. Modelling the application element entity 402 using the system relationships ensures that the infrastructure ensures enforcement of the ALM (e.g., import and export of the referenced components as part of the application module) and hence issues resulting due to improper solution layering and merging are avoided.

FIG. 5 illustrates a workflow 500 for designing a custom page according to various examples. The workflow 500 shows the different flows included between a designer, RP, and datastore, which begins by accessing an editing module (e.g., Editing AppModule) 502 to add a custom page at 504. The custom page is the saved at 506 and posted as a canvas-type application at 508, for example, within a custom application programming interface (API). A record, such as a canvas-type application record (e.g., CanvasAppRecord) is then created at 510 within the datastore and an identification (e.g., a CanvasApp ID or logicalName) is received at 512 by the RP and added to a designer client state at 514. That is, the user (e.g., designer) has access to designer features for the custom page. It should be noted that in various examples, data within the datastore is stored within a set of tables, wherein the tables are sets of records that are used to store data. In some examples, each of the tables includes one or more columns of arranged data.

An application module, for example corresponding to the application module entity 404, is saved at 516 by the designer which then results in the application module being saved in the RP at 518. A root page metadata lookup is then performed at 520. For example, a lookup is performed to determine if a root exists at 522, for example if the root application 208 (in FIG. 2) exists. If the root does exist, then the application module is saved (e.g., SaveAppModule) at 524 within the datastore. If the root does not exist, then root metadata is generated at 526 within the RP (e.g., save metadata within the container defined by the root application 208) and the application module is saved at 524.

An edit application module (e.g., AddEditModule) is then created at 528 within the datastore and saved components received within the RP at 530. For example, the ID, Root Info, etc. are received and then the catalog (e.g., unified application catalog) is updated at 532 as needed (e.g., update to new versions). Once this operation is completed, a save notification is provided to the user at 534, for example, the designer receives a save success notification and the added components (e.g., added component IDs) are displayed.

A user can then publish the application module at 538, which results in the publishing of unpublished changes at 540 within the datastore. As a result, an events job is published (e.g., PublishEvent Job) at 542 with a web hook published (e.g., PublishEvent Web Hook) at 544 within the RP. The application module details are then obtained at 546 within the datastore (e.g., GetAppModuleDetails) and the catalog updated within the RP at 548. The custom page that is created can also be removed at 550, which results in the custom page being removed within the datastore on a subsequent save at 552. Additional cleanup is performed in some examples, such as through an application management user interface (UI), such as for the canvas-type application, that results in a cascade deletion.

In one example, the custom page is defined as follows:

1. Design Callouts:

A. Custom Page has a parent Root App (e.g., Root App is the container for all the custom pages).

B. An App module can have at most one Root App.

C. An app module can have more than one custom page.

2. Root app creation occurs at the time the first save of the app module (create or update) is performed in the new app designer.

3. The Root app is associated to the app module as soon as the Root app is created.

4. Custom page association occurs at the time of save of the app module.

5. No changes can be made in the publish pipeline apart from changes already being performed as part of the app catalog feature.

Thus, in various examples, the root application 208 (in FIG. 2) is configured as a root canvas-type application. That is, in addition to CanvasApp custom pages, the root application 208 defines a “root” CanvasApp that is 1:1 associated with an application module, and linked to the application module through the same schema (e.g., the canvas-type application entity 406 adds a Type property that identifies the linked canvas-type application entity 406 as such). The canvas-type application is configured to provide an association to RP-managed resources that have a 1:1 relationship with the application, such as the union of packaging, union of connections associated with all custom pages, etc. in various examples.

In one example, the relationship of the root canvas-type application (e.g., root application 208) and all custom page canvas-type applications (e.g., canvas-type application entities 406) in the application module (e.g., application module entity 404) is stored only through the application module component relationships in the data store, such as using the application module component entity 408. At publish time, this collection of canvas-type application dependencies for the application is retrieved by the RP, which can then compute the union of all these resources at that time. Then, at runtime, the root application 208 is retrieved and facilitates download of all resources, initialization of connections, etc.

It should be noted that in various examples, the root application management controls application module save (e.g., create & update) through RP, and manages the associated Root CanvasApp within the context of that operation. As a result, modification of the metadata for the application module entity 404 in the datastore is performed within the context of an edit flow. For example, modification of exportable metadata cannot be done post-publish, and as such, the modification is performed as a save function, which is more universal for covering other scenarios, rather than just within the custom page create.

It should be noted that because the application module published at the end of the AppModule import handler and the Descriptor is generated as part of the import handler for runtime consumption, various examples ensure that the application element entities 402 are imported before publishing of the application module entity 404 is triggered. To do so, in one example, a GenericImportHandler for the application element entity 402 is invoked from within a custom handler for the application module entity 404.

Also, to ensure that the application module import is successful when the application module has associated application element entities 402, the sequencing order of solution import handlers (e.g., CanvasApp handler) is changed in some examples and run before the AppModule handler to ensure that when the application element entity 402 is created, the records for the canvas-type application entity 406 already exist in the DB. In some examples, the root application 208 is created as needed (rather than backfilled), and only during an App Module Save operation (e.g., Create or Update). In order to facilitate this process, the application module save is performed through the RP first, which then calls back to the datastore.

In some examples, restrictions are provided on the datastore side to ensure that the application module is in a valid state for import, including:

1. If the application module entity 404 contains the custom page, the application module entity 404 has one Root App,

2. Only one Root App for an application module.

It should be noted that no special handling is needed to ensure the associated application element entities 402 and canvas-type application entities 406 are exported as part of the application module entity 404 because this is relationship driven and the infrastructure handles this aspect.

In some examples, it is assumed that records of the application element entity 402 that are no longer associated with an application module entity 404 are orphaned and deleted once the associated record for the corresponding canvas-type application entity 406 is deleted, through cascade behavior based on the relationship described herein. In other examples, these records are deleted at the time the records are unlinked from the application module entity 404. It should be noted that management of custom pages outside the context of application modules uses an existing canvas-type application management UI in various examples, such as to perform the delete operation. If a canvas-type application is depended up by the application module entity 404, deletion is blocked with an error notification provided. It should be noted that different entities, including different type of entities and modules can be used. That is, while some examples are described in a particular operating or programming environment, the herein described components and elements within the particular operating or programming environment are merely for example. As such, it should be appreciated that different models, components, etc., can be implemented.

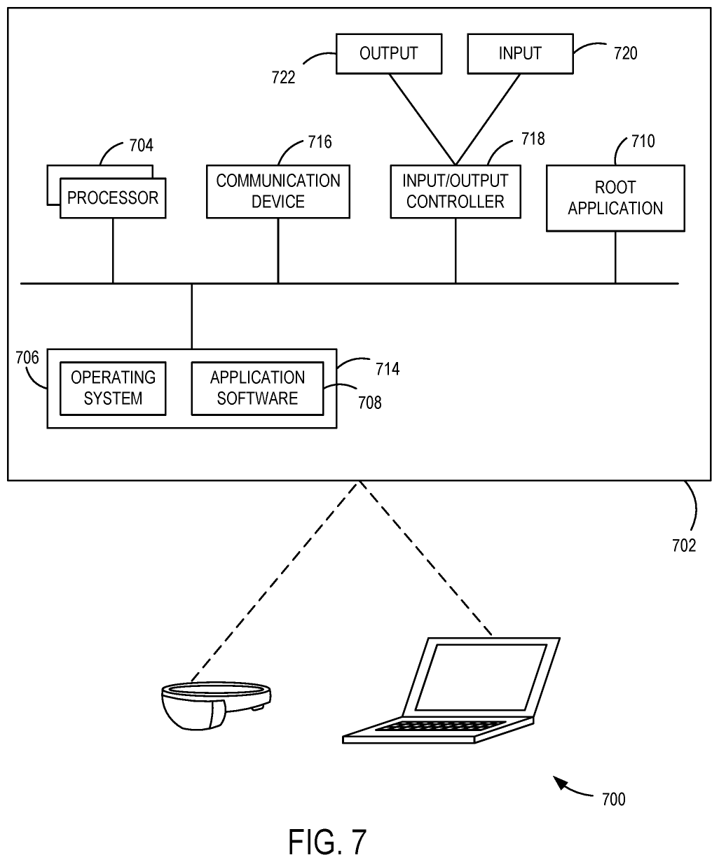

FIG. 6 is a flowchart 600 illustrating operations for creating an application, such as by combining logically organized applications (e.g., model-driven applications) and canvas-type applications into a single application. In some examples, the operations described for flowchart 600 are performed by the computing device 700 of FIG. 7. With the flowchart 600, the application is created to have template-type and canvas-type components.

More particularly, the flowchart 600 commences at operation 602 with storing metadata for a plurality of sub-applications within a root application. For example, the root application is configured as a container to store metadata for one or more canvas-type applications and one or more model-driven applications. In various examples, the sub-applications are arranged within the one or more of the same libraries.

Lifecycle components are coupled through enforced data relationships at 604. For example, ALM is enforced by a model (e.g., the model 400) that defines a relationship with the root application. In some examples, the ALM is enforced across a plurality of sub-applications 210 linked by the root application 208. That is, in various examples, the model is a superset, wherein the canvas-type applications are extension points, and the applications are described in a low code (expressions).

A compiling operation is then performed wherein the sub-applications are compiled into code using the libraries at 606. With various examples, the compiling operation includes embedding the sub-applications without using all the libraries. That is, not all of the libraries are loaded, but instead, the shared libraries allow for loading a single library in some examples. For example, a special placeholder, namely the root application 208, contains the metadata of the combined outputs, which allows for re-using the page of a sub-application without having to load all the combinations (without loading all the libraries). Thus, in some example, metadata production (compilation) is performed such that one or more pages of the sub-applications can use the same one or more libraries. As such, the various dependencies and lifecycles are tied together to prevent failure.

In various examples, the resulting metadata representing the combined model-driven applications plus canvas-type applications includes an application module entity with an associated application element entity, which is related to the canvas-type applications (e.g., Custom Pages that have all the required information under the canvas-type application node). An example XML that illustrates the application module entity having the associated application element entity which is related to the canvas-type application is defined by an <AppModules> element and a <CanvasApp> element, wherein the <AppModules> element defines application module components, role maps, localized names and application elements; and the <CanvasApp> element defines authorization references, connection references, and database references. However, it should be appreciated that the script can include and be defined by different elements, components, entities, etc. as described in more detail herein.

In one example, a determination is made at 608 whether there are any conflicts between the sub-applications. That is, a determination is made whether the sub-applications are using the same target version (e.g., the same target version of a component of a page), such as pointing to the same library. If there is no conflict, then the code can be run at 612. That is, an application created using one or more model-driven sub-applications and one or more canvas-type applications is run at 612.

If a determination is made at 610 that there is a conflict (e.g., using different versions of the same library), then the code is updated at 610 and the updated code is run at 612. That is, the updated code includes the one or more model-driven sub-applications and one or more canvas-type applications using the same target version (e.g., the same version of the same library, such as the newest version). Using the combined metadata information, instead of having different versions, one consistent version of target metadata and a library of dependencies is used by all pages, such that the newest version of an application module element is used to ensure consistency across the application. As described herein, the root application 208 links to the application module elements wherein the schema allows ALM to be performed to ensure consistency. In various examples, the root application 208 is linked to the existing scheme wherein each application has stored metadata of the application module elements that are being used and the updating modifies the compiled code to point to the newest version of the application module elements. Thus, if the code that is compiled at 606 is compiled with one or more different targets using a newer version (e.g., newer versions of one or more target application module elements), the code is modified such that the newest version is used across the pages in all the sub-applications.

Thus, various examples combine model-driven applications and canvas-type applications using ALM in the embedding model to ensure that the compiled code is ready to be run.

### Exemplary Operating Environment

The present disclosure is operable with a computing apparatus 702 according to an embodiment as a functional block diagram 700 in FIG. 7. In one example, components of the computing apparatus 702 may be implemented as a part of an electronic device according to one or more embodiments described in this specification. The computing apparatus 702 comprises one or more processors 704 which may be microprocessors, controllers or any other suitable type of processors for processing computer executable instructions to control the operation of the electronic device. Platform software comprising an operating system 706 or any other suitable platform software may be provided on the apparatus 702 to enable application software 708 to be executed on the device. According to an example, application generation using a root application 710 can be accomplished by software.

Computer executable instructions may be provided using any computer-readable media that are accessible by the computing apparatus 702. Computer-readable media may include, for example, computer storage media such as a memory 714 and communications media. Computer storage media, such as the memory 714, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 714) is shown within the computing apparatus 702, it will be appreciated by a person skilled in the art, that the storage may be distributed or located remotely and accessed via a network or other communication link (e.g. using a communication interface 716).

The computing apparatus 702 may comprise an input/output controller 718 configured to output information to one or more input devices 720 and output devices 722, for example a display or a speaker, which may be separate from or integral to the electronic device. The input/output controller 718 may also be configured to receive and process an input from the one or more input devices 720, for example, a keyboard, a microphone or a touchpad. In one embodiment, the output device 722 may also act as the input device 720. An example of such a device may be a touch sensitive display. The input/output controller 718 may also output data to devices other than the output device 722, e.g. a locally connected printing device. In some embodiments, a user may provide input to the input device(s) 720 and/or receive output from the output device(s) 722.

In some examples, the computing apparatus 702 detects voice input, user gestures or other user actions and provides a natural user interface (NUI). This user input may be used to author electronic ink, view content, select ink controls, play videos with electronic ink overlays and for other purposes. The input/output controller 718 outputs data to devices other than a display device in some examples, e.g. a locally connected printing device.

The functionality described herein can be performed, at least in part, by one or more hardware logic components. According to an embodiment, the computing apparatus 702 is configured by the program code when executed by the processor(s) 704 to execute the embodiments of the operations and functionality described. Alternatively, or in addition, the functionality described herein can be performed, at least in part, by one or more hardware logic components. For example, and without limitation, illustrative types of hardware logic components that can be used include FPGAs, ASICs, ASSPs, SOCs, CPLDs, and GPUs.

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Other examples include the following.

A computerized method for generating an application, the computerized method comprising:
storing metadata corresponding to a plurality of sub-applications, wherein the plurality of sub-applications comprises different types of applications;
coupling lifecycle components of the plurality of sub-applications using one or more data relationships defined by an embedding model and the stored metadata;
compiling the plurality of sub-applications into code, wherein the stored metadata points to a library associated with the plurality of sub-applications, and wherein the library comprises a newest version of one or more of the lifecycle components; and
running the compiled plurality of sub applications.

A system for generating an application, the system comprising:
an application library in a memory storing metadata corresponding to a plurality of sub-applications, wherein the plurality of sub-applications comprises different types of applications;
a design surface implemented on a processor, the design surface configured to receive a selection of a template corresponding to one or more sub-applications of the plurality of sub-applications and receive one or more canvas-type inputs corresponding to one or more sub-applications of the plurality of sub-applications; and
an application lifecycle management (ALM) component implemented on the processor, the ALM component configured to couple lifecycle components of the plurality of sub-applications using one or more data relationships defined by an embedding model and using the stored metadata, and wherein,
the processor is configured to compile the plurality of sub-applications into code, wherein the stored metadata points to a library associated with the plurality of sub-applications, and wherein the library comprises a newest version of one or more of the lifecycle components.

One or more computer storage media having computer-executable instructions for generating an application that, upon execution by a processor, cause the processor to at least:
store metadata corresponding to a plurality of sub-applications, wherein the plurality of sub-applications comprises different types of applications;
couple lifecycle components of the plurality of sub-applications using one or more data relationships defined by an embedding model and the stored metadata;
compile the plurality of sub-applications into code, wherein the stored metadata points to a library associated with the plurality of sub-applications, and wherein the library comprises a newest version of one or more of the lifecycle components; and
run the compiled plurality of sub applications.

Alternatively, or in addition to the other examples described herein, examples include any combination of the following:
wherein the plurality of sub-applications comprises one or more model-driven applications and one or more canvas-type applications.
wherein the embedding model comprises an application module element, and further comprising configuring a root application as a container storing the metadata, and linking the root application to the plurality of sub-applications to manage the lifecycle components.
further comprising updating the version of the one or more lifecycle components in recompiled code in response to a determined conflict with versions in one or more other lifecycle components.
wherein the embedding model comprises an application module entity and a canvas-type application entity linked by an application element, the application element storing the metadata, wherein the application module entity is associated with a model-driven application and the canvas-type application entity is associated with a canvas-driven application.
wherein the library is a same library and further comprising arranging the plurality of sub-applications within the same library.
further comprising:
receiving a selection of a template at a design surface implemented on a user interface, the template corresponding to one or more of the sub-applications; and
receiving one or more canvas-type inputs on the user interface corresponding to one or more of the sub-applications.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of” or, when used in the claims, “consisting of” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the various examples in detail, it will be apparent that modifications and variations are possible without departing from the scope of aspects as defined in the appended claims. As various changes could be made in the above constructions, products, and methods without departing from the scope of aspects describe herein, it is intended that all matter contained in the above description and shown in the accompanying drawings shall be interpreted as illustrative and not in a limiting sense.

What is claimed is:

1. A computerized method for generating an application, the computerized method comprising:
storing metadata corresponding to a plurality of sub-applications, wherein the plurality of sub-applications comprises different types of applications;
coupling lifecycle components of the plurality of sub-applications using one or more data relationships defined by an embedding model and the stored metadata;
compiling the plurality of sub-applications into code, wherein the stored metadata points to a library associated with the plurality of sub-applications, and wherein the library comprises a newest version of one or more of the lifecycle components; and
running the compiled plurality of sub applications.

2. The computerized method of claim 1, wherein the plurality of sub-applications comprises one or more model-driven applications and one or more canvas-type applications.

3. The computerized method of claim 1, wherein the embedding model comprises an application module element, and further comprising configuring a root application as a container storing the metadata, and linking the root application to the plurality of sub-applications to manage the lifecycle components.

4. The computerized method of claim 1, further comprising updating the version of the one or more lifecycle components in recompiled code in response to a determined conflict with versions in one or more other lifecycle components.

5. The computerized method of claim 1, wherein the embedding model comprises an application module entity and a canvas-type application entity linked by an application element, the application element storing the metadata, wherein the application module entity is associated with a model-driven application and the canvas-type application entity is associated with a canvas-type application.

6. The computerized method of claim 1, wherein the library is a same library and further comprising arranging the plurality of sub-applications within the same library.

7. The computerized method of claim 1, further comprising:
receiving a selection of a template at a design surface implemented on a user interface, the template corresponding to one or more of the sub-applications; and
receiving one or more canvas-type inputs on the user interface corresponding to one or more of the sub-applications.

8. A system for generating an application, the system comprising:
an application library in a memory storing metadata corresponding to a plurality of sub-applications, wherein the plurality of sub-applications comprises different types of applications;
a design surface implemented on a processor, the design surface configured to receive a selection of a template corresponding to one or more sub-applications of the plurality of sub-applications and receive one or more canvas-type inputs corresponding to one or more sub-applications of the plurality of sub-applications; and
an application lifecycle management (ALM) component implemented on the processor, the ALM component configured to couple lifecycle components of the plurality of sub-applications using one or more data relationships defined by an embedding model and using the stored metadata, and wherein,
the processor is configured to compile the plurality of sub-applications into code, wherein the stored metadata points to a library associated with the plurality of sub-applications, and wherein the library comprises a newest version of one or more of the lifecycle components.

9. The system of claim 8, wherein the plurality of sub-applications comprises one or more model-driven applications and one or more canvas-type applications.

10. The system of claim 8, wherein the embedding model comprises an application module element, and further comprising a root application configured as a container storing the metadata, the root application linked to the plurality of sub-applications to manage the lifecycle components.

11. The system of claim 8, wherein the processor is further configured to update the version of the one or more lifecycle components in a recompiled code in response to a determined conflict with versions in one or more other lifecycle components.

12. The system of claim 8, wherein the embedding model comprises an application module entity and a canvas-type application entity linked by an application element, the application element storing the metadata, wherein the application module entity is associated with a model-driven application and the canvas-type application entity is associated with a canvas-type application.

13. The system of claim 8, wherein the library is a single library and the processor is further configured to arrange the plurality of sub-applications within the single library.

14. The system of claim 8, wherein the selection of the template corresponding to one or more of the sub-applications of a plurality of sub-applications comprises a selection of model-driven application and the selection of one or more canvas-type inputs corresponding to one or more sub-applications of the plurality of sub-applications comprises a selection of a canvas-type application.

15. One or more computer storage media having computer-executable instructions for generating an application that, upon execution by a processor, cause the processor to at least:
store metadata corresponding to a plurality of sub-applications, wherein the plurality of sub-applications comprises different types of applications;
couple lifecycle components of the plurality of sub-applications using one or more data relationships defined by an embedding model and the stored metadata;
compile the plurality of sub-applications into code, wherein the stored metadata points to a library associated with the plurality of sub-applications, and wherein the library comprises a newest version of one or more of the lifecycle components; and
run the compiled plurality of sub applications.

16. The one or more computer storage media of claim 15, wherein the plurality of sub-applications comprises one or more model-driven applications and one or more canvas-type applications.

17. The one or more computer storage media of claim 15, wherein the embedding model comprises an application module element, and the computer-executable instructions, upon execution by the processor, further cause the processor to configure a root application as a container storing the metadata, and link the root application to the plurality of sub-applications to manage the lifecycle components.

18. The one or more computer storage media of claim 15, wherein the computer-executable instructions, upon execution by the processor, further cause the processor to update the version of the one or more lifecycle components in recompiled code in response to a determined conflict with versions in one or more other lifecycle components.

19. The one or more computer storage media of claim 15, wherein the embedding model comprises an application module entity and a canvas-type application entity linked by an application element, the application element storing the metadata, wherein the application module entity is associated with a model-driven application and the canvas-type application entity is associated with a canvas-type application.

20. The one or more computer storage media of claim 15, wherein the library is a same library and wherein the computer-executable instructions, upon execution by the processor, further cause the processor to arrange the plurality of sub-applications within the same library.
